(19) United States
(12) Patent Application Publication
(10) Pub. No.: US 2017/0168638 A1
(43) Pub. Date: Jun. 15, 2017

(54) RETRACTABLE DISPLAY DEVICE AND CONTROLLING METHOD THEREOF

(71) Applicant: BOE TECHNOLOGY GROUP CO., LTD., Beijing (CN)

(72) Inventors: Shiming Shi, Beijing (CN); Song Song, Beijing (CN); Ming Hsi Wang, Beijing (CN)

(73) Assignee: BOE TECHNOLOGY GROUP CO., LTD., Beijing (CN)

(21) Appl. No.: 15/325,433

(22) PCT Filed: Dec. 28, 2015
(86) PCT No.: PCT/CN2015/099130

§ 371 Date: Jan. 10, 2017

(30) Foreign Application Priority Data
Jun. 5, 2015 (CN) 201510303269.1

(51) Int. Cl. G06F 3/041; G06F 1/32; G06F 3/147

(52) U.S. Cl. CPC G06F 3/0416; G06F 3/147; G06F 3/0412; G06F 1/3262; G06F 1/3265; G06F 2203/04101; G06F 2203/04102

(57) ABSTRACT

The present application discloses a retractable display device comprising a display panel having a first end and a second end opposite to the first end; a retractor for receiving the display panel; wherein the first end is attached to the retractor, the retractor is dimensioned to permit the display panel to be retracted into or extended from the retractor; at least one sensor in proximity of the retractor for generating a position signal indicative of a position in the display panel corresponding to the at least one sensor; and a controller coupled with a circuit board of the retractable display device for generating a control signal upon receiving the position signal, the control signal selectively controls a first portion of the display panel in a first functional mode and a second portion of the display panel in a second functional mode.

### CROSS-REFERENCE TO RELATED APPLICATION

This application claims priority to Chinese Patent Application No. 201510303269.1, filed Jun. 5, 2015, the contents of which are incorporated by reference in the entirety.

### FIELD

The present invention relates to display technology, more particularly, to a retractable display device and a controlling method thereof.

### BACKGROUND

Flexible display panels have been proposed and researched for design and other reasons, particularly in the field of electronic paper technology and active-matrix organic light emitting diode technology. Flexible display panels have the advantages of being ultrathin, impact-resistant, and rollable. Flexible display panels have found a wide range of applications in mobile electronic devices.

### SUMMARY

In one aspect, the present disclosure provides a retractable display device comprising a display panel having a first end and a second end opposite to the first end; a retractor for receiving the display panel; wherein the first end is attached to the retractor, the retractor is dimensioned to permit the display panel to be retracted into or extended from the retractor; at least one sensor in proximity of the retractor for generating a position signal indicative of a position in the display panel corresponding to the at least one sensor; and a controller coupled with a circuit board of the retractable display device for generating a control signal upon receiving the position signal, the control signal selectively controls a first portion of the display panel in a first functional mode and a second portion of the display panel in a second functional mode.

Optionally, the first functional mode comprises a display mode wherein an image display within the first portion is on upon receiving the position signal, the second functional mode comprises a non-display mode wherein an image display within the second portion is off upon receiving the position signal.

Optionally, the second functional mode comprises an energy saving mode wherein an energy saving function within the second portion is on upon receiving the position signal, the first functional mode comprises a normal energy consumption mode wherein an energy saving function within the first portion is off upon receiving the position signal.

Optionally, the first functional mode comprises a full-screen display mode wherein a full screen display within the first portion is on upon receiving the position signal, the second functional mode comprises a partial display mode wherein a partial screen display within the second portion is on upon receiving the position signal.

Optionally, the first functional mode comprises a touch control mode wherein a touch control function within the first portion is on upon receiving the position signal, the second functional mode comprises a non-touch control mode wherein a touch control function within the second portion is off upon receiving the position signal.

Optionally, the first portion substantially overlaps with a portion of the display panel extended from the retractor and the second portion substantially overlaps a portion of the display panel retracted into the retractor.

Optionally, the second portion is completely within the portion of the display panel retracted into the retractor.

Optionally, an area of the display panel corresponding to the at least one sensor is within a distance of around 5 mm from the second portion.

Optionally, the display panel is a touch control display panel.

Optionally, the position signal is a touch signal generated by the at least one sensor and an area of the display panel corresponding to the at least one sensor.

Optionally, the at least one sensor comprises an object made of a conductive material.

Optionally, the at least one sensor further comprises an outer insulating layer over the conductive object.

Optionally, the retractable display device further comprises a plurality of the at least one sensors.

Optionally, at least two of the plurality of the at least one sensors have different sizes.

Optionally, the retractable display device comprises a matrix of the plurality of the at least one sensors.

Optionally, the sensor has a size of no more than 2 mm.

Optionally, the sensor has a size of no less than 15 mm.

Optionally, the display panel is a flexible display panel, the retractor comprises a roller to which the first end is attached and a lockable recoiler coupled to the roller for permitting the flexible display panel to be retracted into or extended from the roller.

Optionally, the retractor further comprises a protective shell over the roller.

Optionally, the display panel is a touch control display panel selected from the group consisting of a hover touch control display panel, an on-cell touch control display panel, and an in-cell touch control display panel.

Optionally, the controller is integrated into the circuit board.

In another aspect, the present disclosure provides a method of controlling a retractable display device as described herein, comprising generating a position signal indicative of a position in the display panel corresponding to the at least one sensor; generating a control signal upon receiving the position signal; and selectively controlling a first portion of the display panel in a first functional mode and a second portion of the display panel in a second functional mode.

Optionally, the first functional mode comprises a display mode and the second functional mode comprises a non-display mode, the method further comprises turning on an image display within the first portion upon receiving the position signal; and turning off an image display within the second portion upon receiving the position signal.

Optionally, the second functional mode comprises an energy saving mode and the first functional mode comprises a normal energy consumption mode, the method further comprises turning on an energy saving function within the second portion upon receiving the position signal; and turning off an energy saving function within the first portion upon receiving the position signal.

Optionally, the first functional mode comprises a full screen display mode and the second functional mode comprises a partial screen display mode, the method further comprises turning on a full screen display within the first portion upon receiving the position signal; and turning on a partial screen display within the second portion upon receiving the position signal.

Optionally, the first functional mode comprises a touch control mode and the second functional mode comprises a non-touch control mode, the method further comprises turning on a touch control function within the first portion upon receiving the position signal; and turning off a touch control function within the second portion upon receiving the position signal.

Optionally, the first portion substantially overlaps with a portion of the display panel extended from the retractor and the second portion substantially overlaps with a portion of the display panel retracted into the retractor.

Optionally, the second portion is completely within the portion of the display panel retracted into the retractor.

Optionally, an area of the display panel corresponding to the at least one sensor is within a distance of around 5 mm from the second portion.

Optionally, the display panel is a touch control display panel.

Optionally, the step of generating the position signal comprises generating a touch signal by the at least one sensor and an area of the display panel corresponding to the at least one sensor.

### BRIEF DESCRIPTION OF THE FIGURES

The following drawings are merely examples for illustrative purposes according to various disclosed embodiments and are not intended to limit the scope of the present invention.

FIG. 1 is diagram illustrating the structure of a retractable display device in certain embodiments.

FIG. 2 is a diagram illustrating an arrangement of multiple sensors in a retractable display device in certain embodiments.

FIG. 3 is a diagram illustrating an image display in a selected portion of the display panel in a retractable display device in certain embodiments.

FIG. 4 is a flow chart illustrating a method of controlling a retractable display device in certain embodiments.

### DETAILED DESCRIPTION

The disclosure will now describe more specifically with reference to the following embodiments. It is to be noted that the following descriptions of some embodiments are presented herein for purpose of illustration and description only, it is not intended to be exhaustive or to be limited to the precise form disclosed.

Retractable display devices have a smaller volume as compared to conventional display devices, and can be conveniently stored and transported. Several problems associated with retractable display devices have been identified in the present disclosure. For example, the retractable display devices still display images within the portion which has been retracted. Because the image display within the retracted portion is not turned off, it results in inefficient and wasteful energy consumption. When the retractable display devices are touch control devices, the retracted portion may inadvertently generate touch signals.

In one aspect, the present disclosure provides a superior retractable display device that avoids all the disadvantages identified above, and a controlling method thereof. For example, the image display, touch control function, energy consumption and many other functionalities can be selectively controlled in the retracted portion and a non-retracted portion of the present retractable display device.

In some embodiments, the retractable display device is a touch control display device. In some embodiments, the retractable display device includes a flexible display panel or a display panel having a flexible portion. In some embodiments, the retractable display device includes a touch control flexible display panel.

In some embodiments, the retractable display device includes a display panel having a first end and a second end opposite to the first end and a retractor for receiving the display panel. The first end is attached to the retractor. The retractor is dimensioned to permit the display panel to be retracted into or extended from the retractor. Optionally, the retractor includes an opening, and the retractor is dimensioned to permit the display panel to be retracted into or extended from the opening. Optionally, the retraction and/or the extension result in a retracted display portion and/or an extended display portion of the display panel.

In some embodiments, the retractable display device further includes at least one sensor in proximity of the retractor for generating a position indicative of a position in the display panel corresponding to the at least one sensor. Optionally, the at least one sensor is in proximity of the opening of the retractor for generating a position indicative of a position in the display panel corresponding to the at least one sensor. Optionally, the at least one sensor is in proximity of an interface between the retracted display portion and the extended display portion for generating a position signal indicative of a relative position of the retracted display portion with respect to the extended display portion. The retractable display device further includes a controller coupled with a circuit board of the retractable display device for generating a control signal upon receiving the position signal. The control signal selectively controls a first portion of the display panel in a first functional mode and a second portion of the display panel in a second functional mode.

For example, the first portion may be a portion that substantially overlaps with the extended display portion. The second portion may be a portion that substantially overlaps with the retracted display portion. Optionally, the first portion substantially overlaps with the extended display portion but may also include a part of the retracted display portion. Optionally, the second portion substantially overlaps with the retracted display portion but may also include a part of the extended display portion. Optionally, the second portion is completely within the retracted display portion. In some retractable display devices, an area of the display panel corresponding to the at least one sensor is within a distance of 5 mm from the second portion.

The functional modes may be any appropriate functional mode of operation. For example, the functional mode may be a certain display mode, a certain touch control mode, or a certain energy saving mode. In some retractable display devices, the first functional mode includes a display mode and the second functional mode includes a non-display mode. That is, an image display within the first portion is turned on upon receiving the position signal, and an image display within the second portion is turned off upon receiving the position signal. In some retractable display devices, the first functional mode includes a normal energy consumption mode and the second functional mode includes an energy saving mode. For example, an energy saving function within the second a portion is turned on upon receiving the position signal, and an energy saving function within the first portion is turned off upon receiving the position signal. In some retractable display devices, the first functional mode includes a full-screen display mode and the second functional mode includes a partial screen display mode. For example, a full screen display function within the first portion is turned on upon receiving the position signal, and a partial screen display function within the second portion is turned on upon receiving the position signal. In some retractable display devices, the first functional mode includes a touch control mode and the second functional mode includes a non-touch control mode. For example, a touch control function within the first portion is turned on upon receiving the position signal, and a touch control function within the second portion is turned off upon receiving the position signal. In some embodiments, the functional mode of operation can be, for example, a breathing mode, a peek view mode, an intermediate mode, etc.

In some retractable display devices, a functional mode may be a mode of multiple operation functionalities. For example, the functional mode may include a certain display mode and a certain touch control mode, or may include a certain energy saving mode and a certain touch control mode. In some embodiments, an image display and a touch control function within the first portion is turned on upon receiving the position signal, and an image display and a touch control function within the second portion is turned off upon receiving the position signal. In some embodiments, an image display and a touch control function within the first portion is turned on, and an energy saving function within the first portion is turned off. In some embodiments, an image display and a touch control function within the second portion is turned off, and an energy saving function within the second portion is turned on.

In some retractable display devices, the display panel is a touch control display panel, e.g., a hover touch control display panel, an on-cell touch control display panel, or an in-cell touch control display panel. Optionally, the position signal is a touch signal generated by the at least one sensor and an area of the display panel corresponding to the at least one sensor. Any appropriate type of touch control device may be practice, including, but are not limited to, resistive, capacitive, optical, sound wave, and electromagnetic touch control device.

The controller may be a separate unit disposed in an appropriate portion in the retractable display device, or may be a part of a circuit board. Optionally, the controller is integrated into the circuit board.

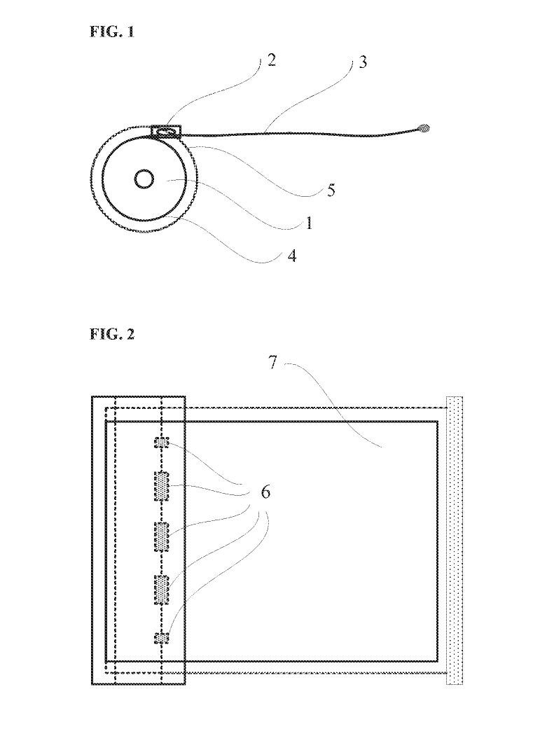

FIG. 1 is diagram illustrating the structure of a retractable display device in certain embodiments. Referring to FIG. 1, the retractable display device in the embodiment includes a retractor 1, a display panel 3, a sensor 2, and a controller. As shown in FIG. 1, the sensor 2 is disposed at a receiving end of the retractor 1. The display panel has a first end attached to the retractor and a second end opposite to the first end. Accordingly, the display panel has a retracted display portion which is retracted inside the retractor 1, and an extended display portion which is outside the retractor 1. The sensor 2 generates a position signal indicative of a relative position of the retracted display portion with respect to the extended display portion. For example, when the display panel 3 is a touch control display panel, the sensor 2 and an area in the display panel 3 corresponding to the sensor 2 may generate a touch signal indicative of a relative position of the retracted display portion with respect to the extended display portion. Depending on the type of touch control mechanism, the sensor 2 may be in touch with, or in close proximity to, the area in the display panel 3 corresponding to the sensor 2. For example, when the touch control display panel is a capacitive type touch control display panel, the sensor 2 may be in touch with the display panel, or is sufficiently close to the display panel so that the capacitance of the touch electrode is detectably changed. The controller receives the touch signal, and controls at least two different portions of the display panel 3, each of which is to be operated in a different functional mode.

The sensor 2 can be made of any type of appropriate material. For example, the sensor 2 may include an object made of a conductive material. Optionally, the sensor 2 further includes an outer insulating layer (e.g., a thin film) over the conductive object. The outer insulating layer may prevent damage to the display panel caused by the sensor 2. An appropriate thickness of the outer insulating layer may be selected so that the sensor 2 can generate a touch signal sufficiently detectable by the controller.

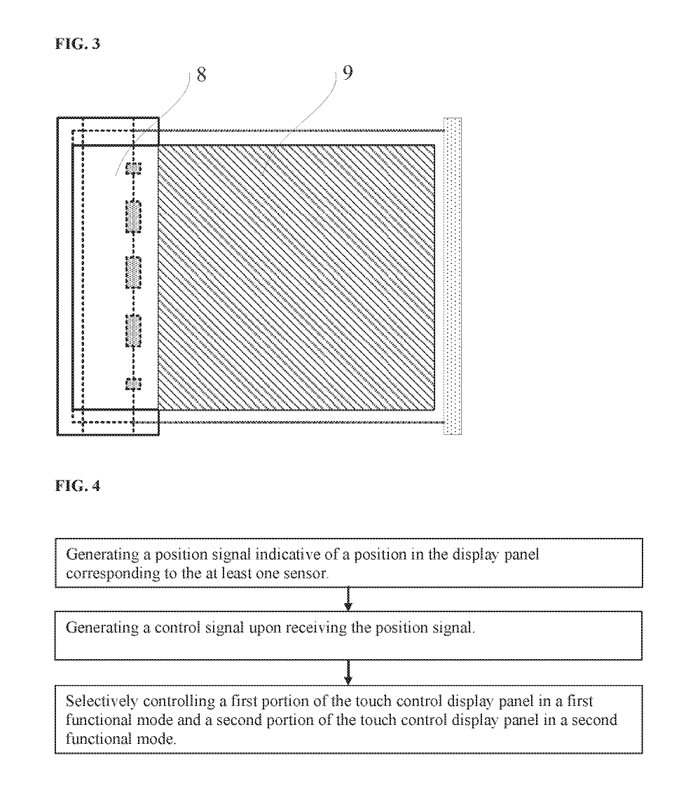

FIG. 3 is a diagram illustrating an image display in a selected portion of the display panel in a retractable display device in certain embodiments. Referring to FIG. 3, the display panel in the embodiment includes a first portion 9 and a second portion 8. As shown in FIG. 3, the first portion 9 substantially overlaps with the extended display portion and the second portion 8 substantially overlaps with the retracted display portion.

FIG. 2 is a diagram illustrating an arrangement of multiple sensors in a retractable display device in certain embodiments. Referring to FIG. 2, the display device in the embodiment includes a plurality of sensors 6 (e.g., five sensors as shown in FIG. 2) Having the plurality of sensor 6 facilitates an accurate determination of the positions of the areas corresponding to the sensors 6. For example, a set of a plurality of position signals from the plurality of sensors 6 can be more easily discerned from other touch signals such as an inadvertently generated noise touch signal. In turn, the relative position of the retracted display portion with respect to the extended display portion may be more accurately determined.

Various other embodiments may be practiced to make the position signals more easily discerned from other signals such as other touch signals. For example, in some embodiments, the display device has at least two of the plurality of the sensors 6 in different sizes. Position signals so generated have a distinct amplitude pattern, which can be more easily discerned from other touch signals not having such an amplitude pattern. In some embodiments, the display device has a matrix of a plurality of sensors 6. Position signals so generated have a distinct position pattern, which can be more easily discerned from other touch signals not having such a position pattern. In some embodiments, the sensor 6 is smaller than an average size of a human finger or larger than twice of the average size of the human finger. In some embodiments, the sensor 6 has a size of no more than 2 mm, e.g., about 1 mm to about 2 mm, about 0.5 mm to about 1.5 mm. In some embodiments, the sensor 6 has a size of no less than 15 mm, e.g., about 15 mm to about 20 mm, about 20 mm to about 25 mm, about 25 mm to about 30 mm. By having a sensor size in this range, the position signal may be more easily discerned from touch signals generated by a user's finger. As a result, the relative position of the retracted display portion with respect to the extended display portion may be more accurately determined.

In some embodiments, the touch control function within the second portion (which substantially overlaps with the retracted portion) is turned off. Accordingly, inadvertent operation within the second portion (or substantially within the retracted portion) may be avoided. Further, the second portion would not generate any touch signals to be confused with the position signals. As a result, the position signal may be more easily discerned.

In some embodiments, the second portion is completely within the retracted display portion. Optionally, an area of the display panel corresponding to the sensor 6 is within a distance of around 5 mm from the second portion. This design ensures that the area of the display panel corresponding to the sensor 6 is still operational (e.g., the touch control is still functional) while the second portion is turned off.

As shown in FIG. 1, in some embodiments, the display panel 3 is a flexible display panel 3, the retractor 1 includes a roller 4 to which the first end of the flexible display panel 3 is attached and a lockable recoiler coupled to the roller 4 for permitting the flexible display panel 3 to be retracted into or extended from the roller 4. Optionally, the retractor 1 further includes a protective shell 5 over the roller 4. The roller 4 receives the retracted flexible display panel 3, the protective shell 5 protects the retracted flexible display panel 3. Various types of rollers and lockable recoilers may be used in connection with the present display device. For example, the roller may be a spool to which the first end of the flexible display panel 3 attached, and the recoiler may be a spiral spring for applying a rotation force. Numerous alternative embodiments may be practiced for retracting the flexible display panel 3. For example, the retractor 1 may be a drawer-type retractor. Optionally, the retractor may be a motor retractor (e.g., a step motor retractor).

Various types of touch control display panels may be used. For example, the display panel may be a hover touch control display panel, an on-cell touch control display panel, or an in-cell touch control display panel. Use of the hover touch control display panel avoids the problem associated with poor contact between the sensor 6 and the display panel 3. The on-cell touch control display panel is made by adhering a touch control panel onto a display panel. In an in-cell touch control display panel, the touch electrodes are disposed on the base substrate of the display panel.

By having a sensor in proximity of an interface between the retracted display portion and the extended display portion, the present retractable display device may generate a position signal indicative of a relative position of the retracted display portion with respect to the extended display portion of the display panel. Based on the relative position, the image display, touch control function, energy consumption and many other functionalities in the retracted portion and a non-retracted portion of the present retractable display device may be selectively controlled. For example, the image display function and the touch control function in the retracted portion may be selectively turned off, and the energy saving function may be turned on in the retracted portion. Accordingly, excessive energy consumption and inadvertent touch panel operation may be avoided.

In another aspect, the present disclosure provides a method of controlling a retractable display device described herein. FIG. 4 is a flow chart illustrating a method of controlling a retractable display device in certain embodiments. Referring to FIG. 4, the method in the embodiment includes generating a position signal indicative of a position in the display panel corresponding to the at least one sensor. Optionally, the position signal is indicative of a relative position of the retracted display portion with respect to the extended display portion. In some embodiment, the method further includes generating a control signal upon receiving the position signal, and selectively controlling a first portion of the display panel in a first functional mode and a second portion of the display panel in a second functional mode.

In some embodiments, the first functional mode includes a display mode and the second functional mode includes a non-display mode. Optionally, the method further includes turning on an image display within the first portion upon receiving the position signal; and turning off an image display within the second portion upon receiving the position signal.

In some embodiments, the second functional mode includes an energy saving mode and the first functional mode includes a normal display mode. Optionally, the method further includes turning on an energy saving function within the second portion upon receiving the position signal; and turning off an energy saving function within the first portion upon receiving the position signal.

In some embodiments, the first functional mode includes a full screen display mode and the second functional mode includes a partial screen display mode. Optionally, the method further includes turning on a full screen display within the first portion upon receiving the position signal; and turning on a partial screen display within the second portion upon receiving the position signal.

In some embodiments, the first functional mode includes a touch control mode and the second functional mode includes a non-touch control mode. Optionally, the method further includes turning on a touch control function within the first portion upon receiving the position signal; and turning off a touch control function within the second portion upon receiving the position signal.

Optionally, the first portion substantially overlaps with the extended display portion and the second portion substantially overlaps with the retracted display portion. Optionally, the second portion is completely within the retracted display portion. Optionally, the display panel is a touch control display panel. Optionally, the step of generating the position signal comprises generating a touch signal by the at least one sensor and an area of the display panel corresponding to the at least one sensor. Optionally, an area of the display panel corresponding to the at least one sensor is within a distance of 5 mm from the second portion.

By detecting the position of the sensor, the present method may determine a relative position of the retracted display portion with respect to the extended display portion of the display panel. Based on the relative position, the present method may selectively control the image display, touch control function, energy consumption and many other functionalities in the retracted portion and a non-retracted portion of the present retractable display device. For example, the image display function and the touch control function in the retracted portion may be selectively turned off, and the energy saving function may be turned on in the retracted portion. Accordingly, excessive energy consumption and inadvertent touch panel operation may be avoided.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A retractable display device, comprising:
a display panel having a first end and a second end opposite to the first end;
a retractor for receiving the display panel; wherein the first end is attached to the retractor, the retractor is dimensioned to permit the display panel to be retracted into or extended from the retractor;
at least one sensor in proximity of the retractor for generating a position signal indicative of a position in the display panel corresponding to the at least one sensor; and
a controller coupled with a circuit board of the retractable display device for generating a control signal upon receiving the position signal, the control signal selectively controls a first portion of the display panel in a first functional mode and a second portion of the display panel in a second functional mode.

2. The retractable display device of claim 1, wherein the first functional mode comprises a display mode wherein an image display within the first portion is on upon receiving the position signal, the second functional mode comprises a non-display mode wherein an image display within the second portion is off upon receiving the position signal.

3. The retractable display device of claim 1, wherein the second functional mode comprises an energy saving mode wherein an energy saving function within the second portion is on upon receiving the position signal, the first functional mode comprises a normal energy consumption mode wherein an energy saving function within the first portion is off upon receiving the position signal.

4. (canceled)

5. The retractable display device of claim 1, wherein the first functional mode comprises a touch control mode wherein a touch control function within the first portion is on upon receiving the position signal, the second functional mode comprises a non-touch control mode wherein a touch control function within the second portion is off upon receiving the position signal.

6. The retractable display device of claim 1, wherein the first portion substantially overlaps with a portion of the display panel extended from the retractor and the second portion substantially overlaps a portion of the display panel retracted into the retractor.

7. The retractable display device of claim 6, wherein the second portion is completely within the portion of the display panel retracted into the retractor.

8. The retractable display device of claim 7, wherein an area of the display panel corresponding to the at least one sensor is within a distance of around 5 mm from the second portion.

9. The retractable display device of claim 1, wherein the display panel is a touch control display panel; the position signal is a touch signal generated by the at least one sensor and an area of the display panel corresponding to the at least one sensor.

10. (canceled)

11. The retractable display device of claim 9, wherein the at least one sensor comprises an object made of a conductive material.

12. (canceled)

13. The retractable display device of claim 1, comprising a plurality of the at least one sensors.

14. The retractable display device of claim 13, wherein at least two of the plurality of the at least one sensors have different sizes.

15. The retractable display device of claim 13, wherein the retractable display device comprises a matrix of the plurality of the at least one sensors.

16. (canceled)

17. (canceled)

18. The retractable display device of claim 1, wherein the display panel is a flexible display panel, the retractor comprises a roller to which the first end is attached and a lockable recoiler coupled to the roller for permitting the flexible display panel to be retracted into or extended from the roller.

19. (canceled)

20. (canceled)

21. (canceled)

22. A method of controlling a retractable display device of claim 1, comprising:
generating a position signal indicative of a position in the display panel corresponding to the at least one sensor;
generating a control signal upon receiving the position signal; and
selectively controlling a first portion of the display panel in a first functional mode and a second portion of the display panel in a second functional mode.

23. The method of claim 22, wherein the first functional mode comprises a display mode and the second functional mode comprises a non-display mode, the method further comprising:
turning on an image display within the first portion upon receiving the position signal; and
turning off an image display within the second portion upon receiving the position signal.

24. The method of claim 22, wherein the second functional mode comprises an energy saving mode and the first functional mode comprises a normal energy consumption mode, the method further comprising:
turning on an energy saving function within the second portion upon receiving the position signal; and
turning off an energy saving function within the first portion upon receiving the position signal.

25. (canceled)

26. The method of claim 22, wherein the first functional mode comprises a touch control mode and the second functional mode comprises a non-touch control mode, the method further comprising:
turning on a touch control function within the first portion upon receiving the position signal; and
turning off a touch control function within the second portion upon receiving the position signal.

27. The method of claim 22, wherein the first portion substantially overlaps with a portion of the display panel extended from the retractor and the second portion substantially overlaps with a portion of the display panel retracted into the retractor.

28. The method of claim 27, wherein the second portion is completely within the portion of the display panel retracted into the retractor.

29. The method of claim 28, wherein an area of the display panel corresponding to the at least one sensor is within a distance of around 5 mm from the second portion.

30. (canceled)

31. (canceled)
